(19) United States
(12) Patent Application Publication
(10) Pub. No.: US 2026/0149358 A1
(43) Pub. Date: May 28, 2026

(54) SEMICONDUCTOR DEVICE

(71) Applicant: FUJI ELECTRIC CO., LTD., Kawasaki-shi (JP)

(72) Inventor: Shigemi MIYAZAWA, Matsumoto-city (JP)

(73) Assignee: FUJI ELECTRIC CO., LTD., Kawasaki-shi (JP)

(21) Appl. No.: 19/342,225

(22) Filed: Sep. 26, 2025

(30) Foreign Application Priority Data
Nov. 28, 2024 (JP) 2024-207275

(51) Int. Cl. H02M 1/088; H02M 7/539

(52) U.S. Cl. CPC H02M 1/088; H02M 7/539

(57) ABSTRACT

A semiconductor device, including: a switching circuit which includes a lower arm switching element, the switching circuit being connected to a load, and being configured to operate the load based on switching drive of the lower arm switching element; and a lower arm control circuit, which includes: a first circuit that uses a ground potential as a reference potential thereof, receives a lower arm drive signal, generates a first drive signal from the received lower arm drive signal, and outputs the first drive signal, and a second circuit that uses a floating potential, different from the ground potential, as a reference potential thereof, executes level inversion of the first drive signal to generate a second drive signal, and executes the switching drive of the lower arm switching element based on the second drive signal.

### CROSS-REFERENCE TO RELATED APPLICATION

This application is based upon and claims the benefit of priority of the prior Japanese Patent Application No. 2024-207275, filed on Nov. 28, 2024, the entire contents of which are incorporated herein by reference.

### BACKGROUND OF THE INVENTION

### 1. Field of the Invention

The embodiment discussed herein relates to a semiconductor device.

### 2. Background of the Related Art

A semiconductor device for driving a motor includes switching elements that control currents flowing through coils inside the motor, and control circuits that controls driving of the switching elements.

As a related technique, for example, there has been proposed a technique of controlling the magnitudes of gate currents in accordance with changes in the output currents of voltage-driven switching elements (Japanese Laid-open Patent Publication No. 2009-213313). In addition, there has been proposed a technique in which a MOS transistor connected in parallel to an insulated gate bipolar transistor is brought into conduction during a time period when the insulated gate bipolar transistor is turned off so as to bypass a current to the MOS transistor (Japanese Laid-open Patent Publication No. 2008-079475).

### SUMMARY OF THE INVENTION

According to an aspect of the present embodiment, there is provided a semiconductor device for operating a load, including: a switching circuit which includes a lower arm switching element, the switching circuit being connected to the load, and being configured to operate the load based on switching drive of the lower arm switching element; and a lower arm control circuit, which includes: a first circuit that uses a ground potential as a reference potential thereof, receives a lower arm drive signal, generates a first drive signal from the received lower arm drive signal, and outputs the first drive signal, and a second circuit that uses a floating potential, different from the ground potential, as a reference potential thereof, executes level inversion of the first drive signal to generate a second drive signal, and executes the switching drive of the lower arm switching element based on the second drive signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of a semiconductor device;

FIG. 2 is a diagram illustrating a configuration example of an inverter apparatus;

FIG. 3 is a diagram illustrating a configuration example of a semiconductor drive device;

FIG. 4 is a diagram illustrating an internal configuration example of a semiconductor control device according to the present embodiment;

FIG. 5 is a diagram illustrating an example of the connection state between the semiconductor control device and coils;

FIG. 6 is a diagram illustrating a configuration example of an upper arm control circuit;

FIG. 7 is a diagram illustrating a configuration example of a control circuit;

FIG. 8 is a diagram illustrating a configuration example of a drive circuit;

FIG. 9 is a diagram illustrating a configuration example of a switching drive unit of a lower arm control circuit;

FIG. 10 is a diagram illustrating a configuration example of the switching drive unit of the lower arm control circuit;

FIG. 11 is a diagram illustrating a configuration example of an inverter circuit;

FIG. 12 is a diagram illustrating a configuration example of an inverter circuit;

FIG. 13 is a diagram illustrating a configuration example of a NAND circuit;

FIG. 14 is a diagram illustrating an example of the relationship between the drive signals of switching elements and the currents flowing through the coils;

FIG. 15 is a diagram illustrating an internal configuration example of a semiconductor control device according to a reference example;

FIG. 16 is a diagram illustrating a configuration example of a switching drive unit of a lower arm control circuit according to a reference example;

FIG. 17 is a diagram illustrating an example of a peripheral circuit configuration of a switching element according to the present embodiment;

FIG. 18 is a diagram illustrating a configuration example of the switching drive unit of the lower arm control circuit according to the present embodiment;

FIG. 19 is a diagram illustrating an example of timing at the time of a switching operation according to the present embodiment;

FIG. 20 is a diagram illustrating an example of a peripheral circuit configuration of the switching element according to the reference example;

FIG. 21 is a diagram illustrating a configuration example of the switching drive unit of the lower arm control circuit according to the reference example;

FIG. 22 is a diagram illustrating an example of timing at the time of a switching operation according to the reference example;

FIG. 23 is a diagram illustrating an example of the dependence of a collector current on a parasitic inductance;

FIG. 24 is a diagram illustrating an example of the dependence of an emitter voltage on the parasitic inductance;

FIG. 25 is a diagram illustrating an example of the dependence of a gate-emitter voltage on the parasitic inductance;

FIG. 26 is a diagram illustrating an example of the dependence of switching loss on the parasitic inductance;

FIG. 27 is a diagram illustrating an example of a cross-sectional structure of a main part of the lower arm control circuit according to the present embodiment; and

FIG. 28 is a diagram illustrating an example of a cross-sectional structure of a main part of the lower arm control circuit according to the reference example.

### DETAILED DESCRIPTION OF THE INVENTION

Hereinafter, an embodiment will be described with reference to the drawings. Note that, in this specification and the drawings, elements having substantially the same configuration are denoted with the same reference numerals, and redundant description thereof will be omitted as appropriate. Further, in the present specification, “connection” means “electrical connection” unless otherwise specified. Further, when the logic level of a voltage or signal is a low potential level, the logic level will be referred to as “Lo level”. When the logic level is a high potential level, the logic level will be referred to as “Hi level”.

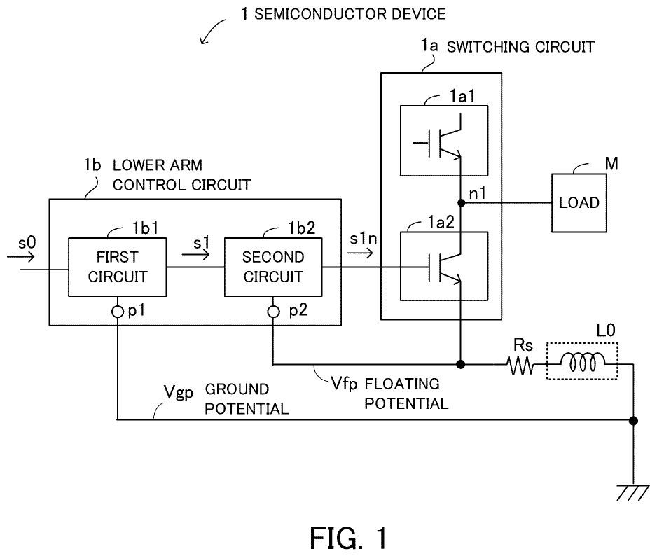

FIG. 1 is a diagram illustrating an example of a semiconductor device. The semiconductor device 1 includes a switching circuit 1a and a lower arm control circuit 1b. The switching circuit 1a includes an upper arm switching element 1a1 and a lower arm switching element 1a2, and the upper arm switching element 1a1 and the lower arm switching element 1a2 are connected in series. The switching circuit 1a is, for example, a half-bridge circuit.

A load M is connected to a connection node n1 between the low-potential-side electrode of the upper arm switching element 1a1 and the high-potential-side electrode of the lower arm switching element 1a2. The load M operates based on switching drive of the upper arm switching element 1a1 and the lower arm switching element 1a2.

The lower arm control circuit 1b includes a first circuit 1b1 and a second circuit 1b2. The first circuit 1b1 corresponds to the input part of the lower arm control circuit 1b, receives a lower arm drive signal s0 transmitted from a control unit (not illustrated), generates a first drive signal s1 from the lower arm drive signal s0, and outputs the first drive signal s1.

The reference potential of the first circuit 1b1 is a ground potential Vgp via a reference potential terminal p1 (a first reference potential terminal). The ground potential Vgp is a potential of the entire system including the semiconductor device 1 and is 0 V (GND). Therefore, the reference potential terminal p1 of the first circuit 1b1 is connected to GND.

The second circuit 1b2 corresponds to the output part of the lower arm control circuit 1b, executes level inversion of the first drive signal s1 to generate a second drive signal s1n, and executes switching drive of the lower arm switching element 1a2 based on the second drive signal s1n.

The reference potential of the second circuit 1b2 is a floating potential Vfp, which is separated from the ground potential Vgp, via a reference potential terminal (a second reference potential terminal) p2. The floating potential Vfp is a potential generated at the low-potential-side electrode of the lower arm switching element 1a2. Therefore, the reference potential terminal p2 of the second circuit 1b2 is connected to the low-potential-side electrode of the lower arm switching element 1a2.

On the other hand, a resistor Rs (a resistive element) for current detection is disposed between the low-potential-side electrode of the lower arm switching element 1a2 and GND, and one end of the resistor Rs is connected to the reference potential terminal p2 of the second circuit 1b2 and the low-potential-side electrode of the lower arm switching element 1a2. Between the reference potential terminal p1 of the first circuit 1b1 and the other end of the resistor Rs, there is a parasitic inductance (a wiring inductance) L0 due to the resistor Rs and the wiring pattern, and the other end of the resistor Rs is connected to the reference potential terminal p1 of the first circuit 1b1 and GND via the parasitic inductance L0.

As described above, in the semiconductor device, the reference potential terminal of the second circuit located at the output part of the lower arm control circuit is connected to the low-potential-side electrode of the lower arm switching element, and the floating potential separated from the ground potential is used as the reference potential of the second circuit. In this way, it is possible to suppress a decrease in current change rate due to the parasitic inductance when the lower arm switching element is turned off, and it is possible to shorten the time needed to interrupt the current when the lower arm switching element is turned off. As a result, the switching loss is reduced.

### Configuration of Inverter Apparatus Using Semiconductor Device

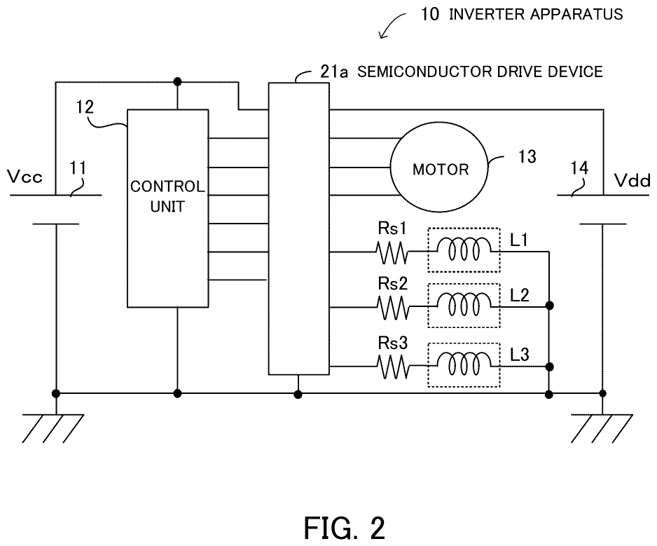

Hereinafter, the present embodiment will be described in detail. FIG. 2 is a diagram illustrating a configuration example of an inverter apparatus. This inverter apparatus 10 includes a power supply 11, a control unit 12, a motor 13, a power supply 14, resistors Rs1, Rs2, and Rs3, and a semiconductor drive device 21a having the functions of the semiconductor device 1.

The power supply 11 supplies a supply voltage Vcc and is, for example, an automobile battery with Vcc=15 V. The control unit 12 is, for example, an electronic control unit (ECU) of an automobile. The motor 13 corresponds to the load M in FIG. 1 and is, for example, a three-phase AC motor. The power supply 14 supplies a power supply voltage Vdd and is, for example, an automobile battery with Vdd=400 V. The semiconductor drive device 21a drives the motor 13 based on upper arm and lower arm drive signals output from the control unit 12.

One end of each of the current-detection resistors Rs1, Rs2, and Rs3 is connected to the lower arm side of the semiconductor drive device 21a. A parasitic inductance L1 due to the resistor Rs1 and the wiring pattern exists on the wiring between the other end of the resistor Rs1 and the GND.

Similarly, a parasitic inductance L2 due to the resistor Rs2 and the wiring pattern exists on the wiring between the other end of the resistor Rs2 and the GND, and a parasitic inductance L3 due to the resistor Rs3 and the wiring pattern exists on the wiring between the other end of the resistor Rs3 and the GND.

### Configuration Example of Semiconductor Drive Device 21a

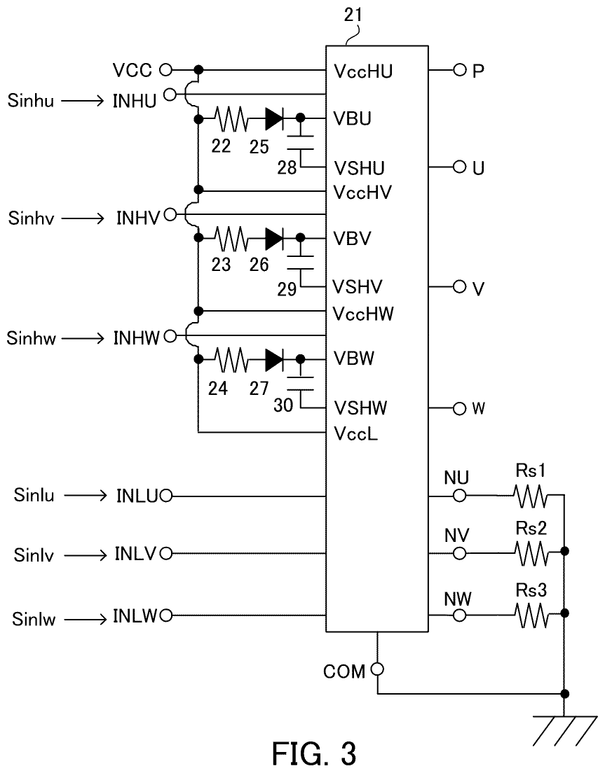

FIG. 3 is a diagram illustrating a configuration example of the semiconductor drive device. The semiconductor drive device 21a illustrated in FIG. 2 includes a semiconductor control device 21, resistors 22, 23, and 24, diodes 25, 26, and 27, and capacitors 28, 29, and 30.

In addition, the semiconductor control device 21 includes: a terminal VCC, which is a power supply terminal; a terminal P; and a terminal COM, which is a device common ground terminal. The terminal VCC is connected to the positive terminal of the power supply 11 in FIG. 2, and the terminal P is connected to the positive terminal of the power supply 14 in FIG. 2. The terminal COM is connected to GND.

The semiconductor control device 21 further includes a terminal INHU (a high-side U-phase input terminal), a terminal INHV (a high-side V-phase input terminal), a terminal INHW (a high-side W-phase input terminal), a terminal INLU (a low-side U-phase input terminal), a terminal INLV (a low-side V-phase input terminal), and a terminal INLW (a low-side W-phase input terminal).

The terminal INHU, the terminal INHV, and the terminal INHW receive high-side upper arm drive signals Sinhu, Sinhv, and Sinhw, respectively, which are output from the control unit 12. The terminal INLU, the terminal INLV, and the terminal INLW receive low-side lower arm drive signals Sinlu, Sinlv, and Sinlw, respectively, which are output from the control unit 12.

The semiconductor control device 21 includes a terminal U (a U-phase output terminal), a terminal V (a V-phase output terminal), a terminal W (a W-phase output terminal) for operating the motor 13, and also includes a terminal NU (an inverted U-phase output terminal), a terminal NV (an inverted V-phase output terminal), and a terminal NW (an inverted W-phase output terminal). The terminal U, the terminal V, and the terminal W are connected to the motor 13.

The terminal NU is connected to one end of the resistor Rs1 illustrated in FIG. 2, the terminal NV is connected to one end of the resistor Rs2 illustrated in FIG. 2, and the terminal NW is connected to one end of the resistor Rs3 illustrated in FIG. 2. The other end of each of the resistors Rs1, Rs2, and Rs3 is connected to GND (illustration of the parasitic inductances is omitted).

Furthermore, the semiconductor control device 21 includes a terminal VccHU (a high-side U-phase power supply terminal), a terminal VccHV (a high-side V-phase power supply terminal), a terminal VccHW (a high-side W-phase power supply terminal), and a terminal VccL (a low-side power supply terminal).

In addition, the semiconductor control device 21 includes a terminal VBU (a high-side U-phase drive power supply terminal), a terminal VBV (a high-side V-phase drive power supply terminal), a terminal VBW (a high-side W-phase drive power supply terminal), a terminal VSHU (a high-side U-phase low potential terminal), a terminal VSHV (a high-side V-phase low potential terminal), and a terminal VSHW (a high-side W-phase low potential terminal).

Regarding the connection relationship among the resistors 22, 23, and 24, the diodes 25, 26, and 27, and the capacitors 28, 29, and 30, one end of the resistor 22 is connected to the terminal VCC, the terminal VccHU, the terminal VccHV, one end of the resistor 23, the terminal VccHW, one end of the resistor 24, and the terminal VccL.

The other end of the resistor 22 is connected to the anode of the diode D25, the cathode of the diode D25 is connected to the terminal VBU and one end of the capacitor 28, and the other end of the capacitor 28 is connected to the terminal VSHU.

The other end of the resistor 23 is connected to the anode of the diode D26, the cathode of the diode D26 is connected to the terminal VBV and one end of the capacitor 29, and the other end of the capacitor 29 is connected to the terminal VSHV.

The other end of the resistor 24 is connected to the anode of the diode D27, the cathode of the diode D27 is connected to the terminal VBW and one end of the capacitor 30, and the other end of the capacitor 30 is connected to the terminal VSHW.

The resistor 22, the diode 25, and the capacitor 28 constitute a bootstrap circuit on the U-phase side, the resistor 23, the diode 26, and the capacitor 29 constitute a bootstrap circuit on the V-phase side, and the resistor 24, the diode 27, and the capacitor 30 constitute a bootstrap circuit on the W-phase side. When the potentials of the terminals VSHU, VSHV, and VSHW are at the Lo level, the capacitors 28, 29, and 30 are charged to a voltage equivalent to the power supply voltage Vcc.

### Internal Configuration Example of Semiconductor Control Device 21

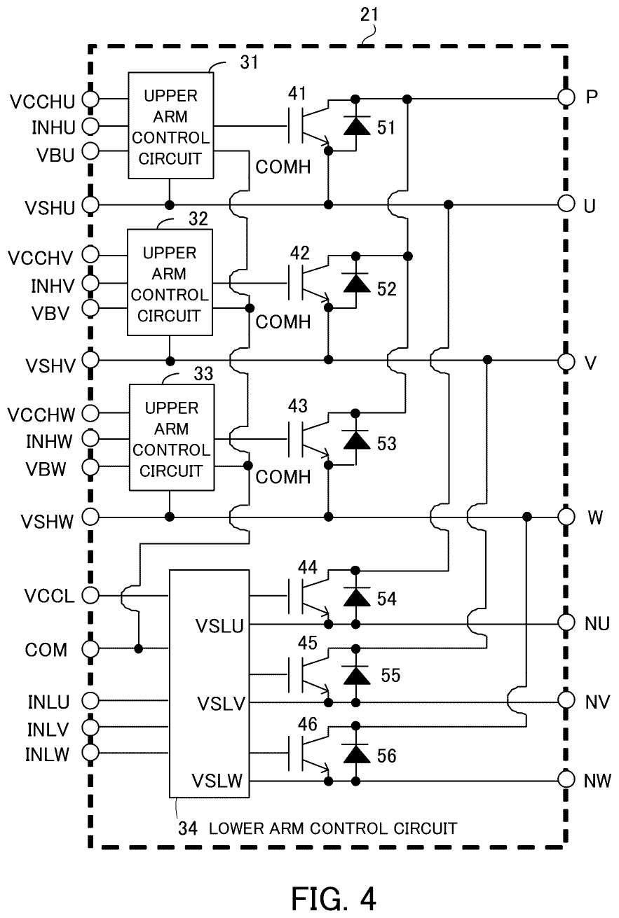

FIG. 4 is a diagram illustrating an internal configuration example of the semiconductor control device according to the present embodiment. The semiconductor control device 21 includes: upper arm control circuits 31, 32, and 33, which are high voltage ICs (HVICs); a lower arm control circuit 34, which is a low voltage IC (LVIC); switching elements 41, 42, 43, 44, 45, and 46; and freewheeling diodes (FWDs) 51, 52, 53, 54, 55, and 56. The switching elements 41, 42, and 43 are upper arm switching elements, and the switching elements 44, 45, and 46 are lower arm switching elements. The FWDs 51, 52, and 53 are upper arm freewheeling diodes, and the FWDs 54, 55, and 56 are lower arm freewheeling diodes.

The switching elements 41, 42, 43, 44, 45, and 46 are, for example, insulated gate bipolar transistors (IGBTs). Alternatively, power metal-oxide-semiconductor field-effect transistors (MOSFETs) may be used.

The upper arm control circuit 31 controls a current flowing through the switching element 41, the upper arm control circuit 32 controls a current flowing through the switching element 42, and the upper arm control circuit 33 controls a current flowing through the switching element 43. The lower arm control circuit 34 controls currents flowing through the switching elements 44, 45, and 46.

Here, the control electrode (which hereinafter may be referred to as a gate) of the switching element 41 is connected to the output terminal of the upper arm control circuit 31. The high-potential-side electrode (which hereinafter may also be referred to as a collector) of the switching element 41 is connected to the collector of the switching element 42, the collector of the switching element 43, the cathode of the FWD 51, the cathode of the FWD 52, the cathode of the FWD 53, and the terminal P.

The low-potential-side electrode (which hereinafter may be referred to as an emitter) of the switching element 41 is connected to the terminal VSHU, the anode of the FWD 51, the terminal U, the collector of the switching element 44, and the cathode of the FWD 54.

The gate of the switching element 42 is connected to the output terminal of the upper arm control circuit 32. The emitter of the switching element 42 is connected to the terminal VSHV, the anode of the FWD 52, the terminal V, the collector of the switching element 45, and the cathode of the FWD 55.

The gate of the switching element 43 is connected to the output terminal of the upper arm control circuit 33. The emitter of the switching element 43 is connected to the terminal VSHW, the anode of the FWD 53, the terminal W, the collector of the switching element 46, and the cathode of the FWD 56.

The gate of the switching element 44 is connected to a first output terminal of the lower arm control circuit 34, and the emitter of the switching element 44 is connected to a terminal VSLU, the anode of the FWD 54, and the terminal NU. The gate of the switching element 45 is connected to a second output terminal of the lower arm control circuit 34, and the emitter of the switching element 45 is connected to a terminal VSLV, the anode of the FWD 55, and the terminal NV.

The gate of the switching element 46 is connected to a third output terminal of the lower arm control circuit 34, and the emitter of the switching element 46 is connected to a terminal VSLW, the anode of the FWD 56, and the terminal NW. In addition, each of the upper arm control circuits 31, 32, and 33 has a terminal COMH. These terminals COMH are connected to the terminal COM of the lower arm control circuit 34, and are connected to GND. The terminal VSLU, the terminal VSLV, and the terminal VSLW will be described later.

### Connection State Between Semiconductor Control Device and Coils

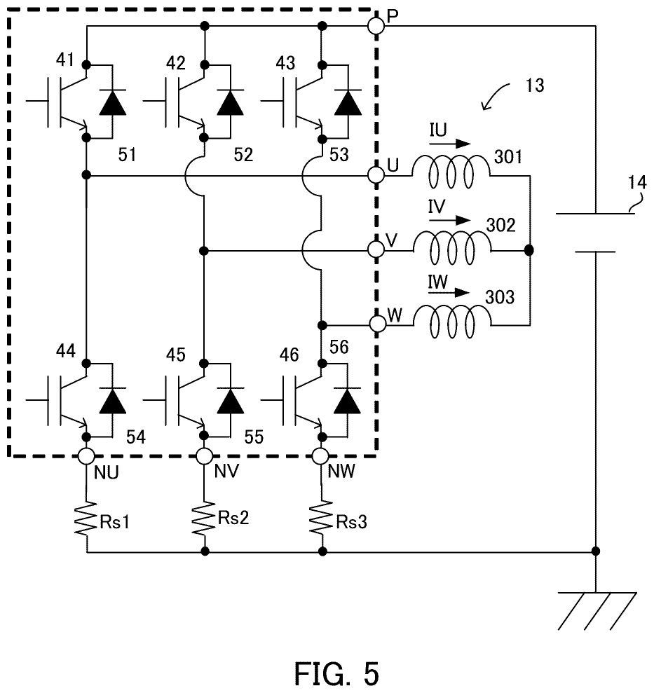

FIG. 5 is a diagram illustrating an example of the connection state between the semiconductor control device and coils. The motor 13 is a three-phase AC motor, and includes a U-phase coil 301, a V-phase coil 302, and a W-phase coil 303.

One end of the coil 301 is connected to the terminal U, one end of the coil 302 is connected to the terminal V, and one end of the coil 303 is connected to the terminal W. The other end of the coil 301 is connected to the other end of the coil 302 and the other end of the coil 303. A current IU flows through the coil 301 via the terminal U, a current IV flows through the coil 302 via the terminal V, and a current IW flows through the coil 303 via the terminal W.

### Configuration Example of Upper Arm Control Circuit 31

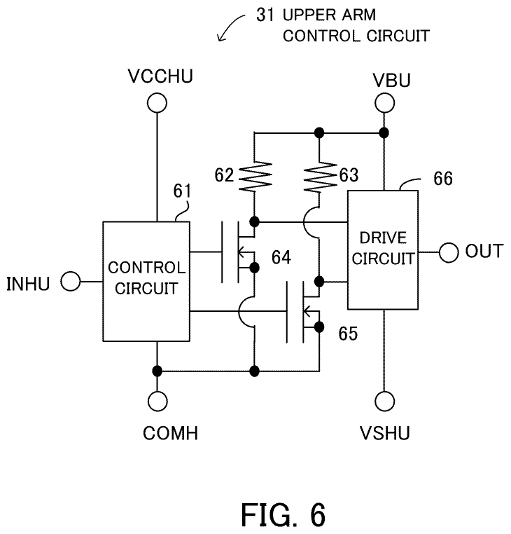

FIG. 6 is a diagram illustrating a configuration example of an upper arm control circuit. Since the upper arm control circuits 31, 32, and 33 may have the same configuration, the upper arm control circuit 31 will be described. The upper arm control circuit 31 includes a control circuit 61, a drive circuit 66, resistors 62 and 63, and switching elements 64 and 65, and has a structure configured on one chip. NMOS transistors are used as the switching elements 64 and 65.

The terminal VCCHU is connected to the power supply terminal of the control circuit 61. The terminal INHU is connected to the input terminal of the control circuit 61. A first output terminal of the control circuit 61 is connected to the gate of the switching element 64, and a second output terminal of the control circuit 61 is connected to the gate of the switching element 65.

The terminal VBU is connected to one end of the resistor 62, one end of the resistor 63, and the power supply terminal of the drive circuit 66. The other end of the resistor 62 is connected to the drain of the switching element 64 and a first input terminal of the drive circuit 66, and the other end of the resistor 63 is connected to the drain of the switching element 65 and a second input terminal of the drive circuit 66.

The terminal COMH is connected to the reference potential terminal of the control circuit 61, the source of the switching element 64, and the source of the switching element 65. The output terminal of the drive circuit 66 is connected to the terminal OUT, and the reference potential terminal of the drive circuit 66 is connected to the terminal VSHU.

Here, the resistor 62 and the switching element 64 function as a level shift circuit, and the resistor 63 and the switching element 65 function as a level shift circuit. When the gate voltages of the switching elements 64 and 65 are at the Hi level, the drain voltages of the switching elements 64 and 65 are at the same potential as the terminal COMH. When the gate voltages of the switching elements 64 and 65 are at the Lo level, the drain voltages of the switching elements 64 and 65 are at the same potential as the terminal VBU.

### Configuration Example of Control Circuit 61

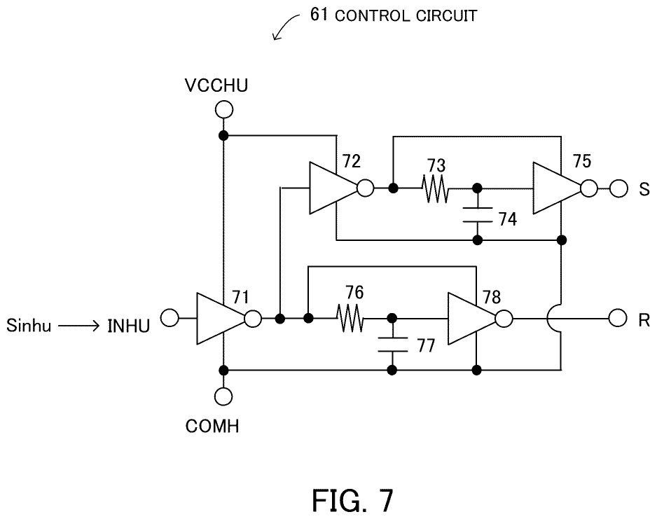

FIG. 7 is a diagram illustrating a configuration example of the control circuit. The control circuit 61 includes a terminal VCCHU, a terminal COMH, a terminal INHU, a terminal S, a terminal R, inverter circuits 71, 72, 75, and 78, resistors 73 and 76, and capacitors 74 and 77.

The terminal VCCHU is connected to the power supply terminals of the inverter circuits 71 and 72. The terminal INHU to which the upper arm drive signal Sinhu is input from the control unit 12 is connected to the input terminal of the inverter circuit 71. The output terminal of the inverter circuit 71 is connected to the input terminal of the inverter circuit 72, one end of the resistor 76, and the power supply terminal of the inverter circuit 78. The output terminal of the inverter circuit 72 is connected to one end of the resistor 73 and a power supply terminal of the inverter circuit 75.

The other end of the resistor 73 is connected to one end of the capacitor 74 and the input end of the inverter circuit 75. The other end of the resistor 76 is connected to one end of the capacitor 77 and the input end of the inverter circuit 78. The other end of the capacitor 74 is connected to the reference potential terminal of the inverter circuit 72, the reference potential terminal of the inverter circuit 75, the reference potential terminal of the inverter circuit 78, the other end of the capacitor 77, the reference potential terminal of the inverter circuit 71, and the terminal COMH. The output terminal of the inverter circuit 75 is connected to the terminal S, and the output terminal of the inverter circuit 78 is connected to the terminal R.

The resistor 73 and the capacitor 74 constitute a delay circuit, and the resistor 76 and the capacitor 77 constitute a delay circuit. When the output voltage levels of the inverter circuits 71 and 72 change, the input voltage levels of the inverter circuits 75 and 78 change with a delay.

The control circuit 61 outputs a pulse signal when the upper arm drive signal Sinhu output from the control unit 12 is input to the terminal INHU. For example, when the voltage of the upper arm drive signal Sinhu increases from less than 2.5 V to 2.5 V or more, a Hi-level voltage pulse is output from the terminal S. The voltage pulse drops to the Lo level after a certain time (for example, 0.1 μs) elapses.

When the voltage of the upper arm drive signal Sinhu decreases from 2.5 V or more to less than 2.5 V, a Hi-level voltage pulse is output from the terminal R. When the voltage level of the upper arm drive signal Sinhu does not change, the voltage levels of the terminal S and the terminal R are Lo level.

### Configuration Example of Drive Circuit 66

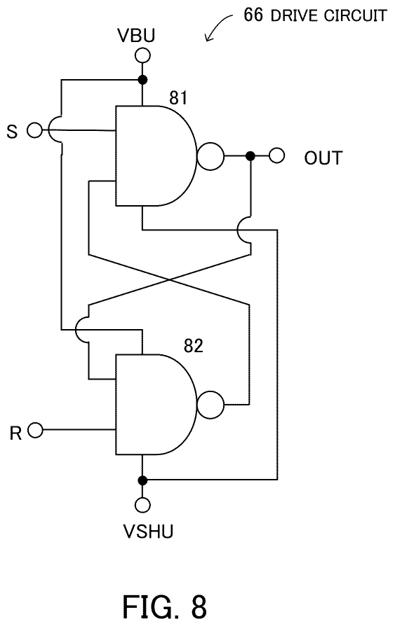

FIG. 8 is a diagram illustrating a configuration example of the drive circuit. The drive circuit 66 includes a terminal VBU, a terminal VSHU, a terminal S, a terminal R, a terminal OUT, and NAND circuits 81 and 82.

The terminal VBU is connected to the power supply terminal of the NAND circuit 81 and the power supply terminal of the NAND circuit 82. The terminal VSHU is connected to the reference potential terminal of the NAND circuit 81 and the reference potential terminal of the NAND circuit 82.

The terminal S is connected to a first input terminal of the NAND circuit 81, and the terminal R is connected to a first input terminal of the NAND circuit 82. The output terminal of the NAND circuit 81 is connected to the terminal OUT and a second input terminal of the NAND circuit 82. The output terminal of the NAND circuit 82 is connected to a second input terminal of the NAND circuit 81.

Here, the drive circuit 66 functions as an RS latch circuit. The voltage levels of the terminals S and R are the Hi level in a steady state. When the upper arm drive signal Sinhu input to the terminal INHU of the control circuit 61 illustrated in FIG. 7 changes from the Lo level to the Hi level, a Lo-level pulse signal is input to the terminal S of the drive circuit 66, and the voltage level of the terminal OUT rises to the Hi level.

When the upper arm drive signal Sinhu input to the terminal INHU of the control circuit 61 illustrated in FIG. 7 changes from the Hi level to the Lo level, a Lo-level pulse signal is input to the terminal R of the drive circuit 66, and the voltage level of the terminal OUT becomes the Lo level. When the voltage of the terminal OUT is at the Hi level, the switching element 41 to which the terminal OUT is connected is turned on. When the voltage of the terminal OUT is at the Lo level, the switching element 41 is turned off.

### Configuration Example of Switching Drive Unit of Lower Arm Control Circuit 34

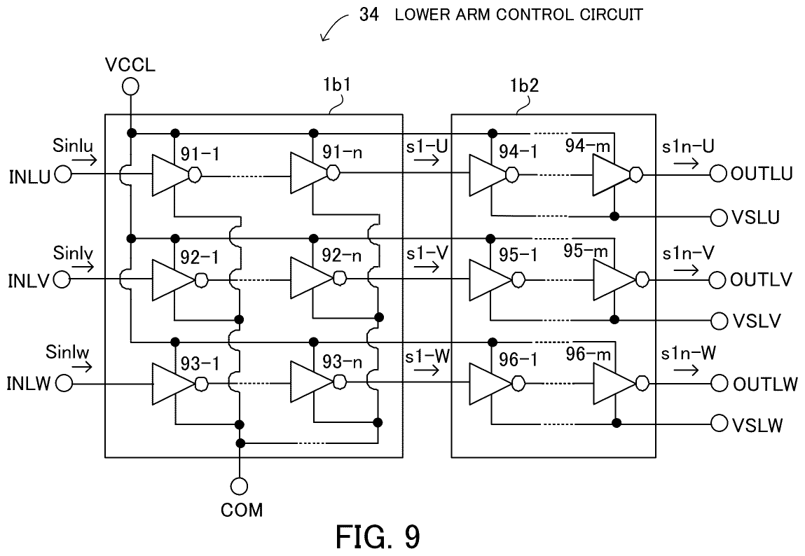

FIG. 9 is a diagram illustrating a configuration example of a switching drive unit of the lower arm control circuit. The lower arm control circuit 34 includes the first circuit 1b1 and the second circuit 1b2 illustrated in FIG. 1. The first circuit 1b1 includes an odd number of inverter circuits (first inverter circuits) connected in series for each phase.

That is, an odd number of inverter circuits 91-1, . . . , and 91-n (n=1, 3, 5, . . . ) are connected in series to the inverted U phase, and the input terminal of the inverter circuit 91-1 is connected to the terminal INLU. The power supply terminals of the inverter circuits 91-1, . . . , and 91-n are connected to the terminal VCCL, and the reference potential terminals thereof are connected to the terminal COM.

An odd number of inverter circuits 92-1, . . . , and 92-n (n=1, 3, 5, . . . ) are connected in series to the inverted V phase, and the input terminal of the inverter circuit 92-1 is connected to the terminal INLV. The power supply terminals of the inverter circuits 92-1, . . . , and 92-n are connected to the terminal VCCL, and the reference potential terminals thereof are connected to the terminal COM. 100 Further, an odd number of inverter circuits 93-1, . . . , and 93-n (n=1, 3, 5, . . . ) are connected in series to the inverted W-phase, and the input terminal of the inverter circuit 93-1 is connected to the terminal INLW. The power supply terminals of the inverter circuits 93-1, . . . , and 93-n are connected to the terminal VCCL, and the reference potential terminals thereof are connected to the terminal COM.

On the other hand, in the second circuit 1b2, an odd number of inverter circuits (second inverter circuits) connected in series are arranged for each phase. An odd number of inverter circuits 94-1, . . . , and 94-m (m=1, 3, 5, . . . ) are connected in series to the inverted U phase. The input terminal of the inverter circuit 94-1 is connected to the output terminal of the inverter circuit 91-n, and the output terminal of the inverter circuit 94-m is connected to a terminal OUTLU. The power supply terminals of the inverter circuits 94-1, . . . , and 94-m are connected to the terminal VCCL, and the reference potential terminals thereof are connected to the terminal VSLU.

Inverter circuits 95-1, . . . , and 95-m are arranged for the inverted V phase. The input terminal of the inverter circuit 95-1 is connected to the output terminal of the inverter circuit 92-n, and the output terminal of the inverter circuit 95-m is connected to a terminal OUTLV. The power supply terminals of the inverter circuits 95-1, . . . , and 95-m are connected to the terminal VCCL, and the reference potential terminals thereof are connected to the terminal VSLV.

Further, inverter circuits 96-1, . . . , and 96-m are arranged for the inverted W-phase. The input terminal of the inverter circuit 96-1 is connected to the output terminal of the inverter circuit 93-n, and the output terminal of the inverter circuit 96-m is connected to a terminal OUTLW. The power supply terminals of the inverter circuits 96-1, . . . , and 96-m are connected to the terminal VCCL, and the reference potential terminals thereof are connected to the terminal VSLW.

The first circuit 1b1 generates first drive signals by level-shifting a first voltage level of the lower arm drive signals to a second voltage level higher than the first voltage level, and the second circuit 1b2 outputs second drive signals obtained by level-inverting the first drive signals.

For the inverted U phase, the first circuit 1b1 generates a first drive signal s1-U by level-shifting a first voltage level (for example, 5 V) of the lower arm drive signal Sinlu to a second voltage level (for example, 15 V). The second circuit 1b2 generates a second drive signal s1n-U by inverting the level of the first drive signal s1-U and outputs the second drive signal s1n-U from the terminal OUTLU.

For the inverted V phase, the first circuit 1b1 generates a first drive signal s1-V by level-shifting the first voltage level (for example, 5 V) of the lower arm drive signal Sinlv to the second voltage level (for example, 15 V). The second circuit 1b2 generates a second drive signal s1n-V by inverting the level of the first drive signal s1-V, and outputs the second drive signal s1n-V from the terminal OUTLV.

For the inverted W phase, the first circuit 1b1 generates a first drive signal s1-W by level-shifting the first voltage level (for example, 5 V) of the lower arm drive signal Sinlw to the second voltage level (for example, 15 V). The second circuit 1b2 generates a second drive signal s1n-W by inverting the level of the first drive signal s1-W and outputs the second drive signal s1n-W from the terminal OUTLW.

Since an odd number of inverter circuits are disposed in the first circuit 1b1 and an odd number of inverter circuits are disposed in the second circuit 1b2, an even number of inverter circuits are disposed for each phase. Therefore, when a Hi-level lower arm drive signal is input to the lower arm control circuit 34, a Hi-level second drive signal is output, and when a Lo-level lower arm drive signal is input to the lower arm control circuit 34, a Lo-level second drive signal is output.

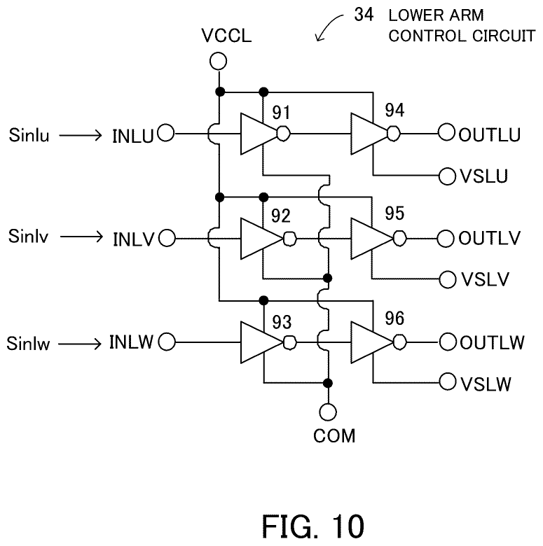

FIG. 10 is a diagram illustrating a configuration example of the switching drive unit of the lower arm control circuit. FIG. 10 illustrates a configuration in which the first circuit 1b1 includes a single inverter circuit for each phase. The lower arm control circuit 34 includes a terminal VCCL, a terminal COM, a terminal INLU, a terminal INLV, a terminal INLW, a terminal OUTLU, a terminal OUTLV, a terminal OUTLW, a terminal VSLU, a terminal VSLV, a terminal VSLW, inverter circuits 91, 92, and 93, and inverter circuits 94, 95, and 96.

The lower arm control circuit 34 turns on and off the switching element 44 based on the lower arm drive signal Sinlu input to the terminal INLU from the control unit 12. Similarly, the lower arm control circuit 34 turns on and off the switching element 45 based on the lower arm drive signal Sinlv input to the terminal INLV from the control unit 12. Further, the lower arm control circuit 34 turns on and off the switching element 46 based on the lower arm drive signal Sinlw input to the terminal INLW from the control unit 12.

The terminal VCCL is connected to the power supply terminals of the inverter circuits 91, 92, and 93 and the inverter circuits 94, 95, and 96. The terminal INLU is connected to the input terminal of the inverter circuit 91, the terminal INLV is connected to the input terminal of the inverter circuit 92, and the terminal INLW is connected to the input terminal of the inverter circuit 93.

The output terminal of the inverter circuit 91 is connected to the input terminal of the inverter circuit 94, the output terminal of the inverter circuit 92 is connected to the input terminal of the inverter circuit 95, and the output terminal of the inverter circuit 93 is connected to the input terminal of the inverter circuit 96.

The output terminal of the inverter circuit 94 is connected to the terminal OUTLU, the output terminal of the inverter circuit 95 is connected to the terminal OUTLV, and the output terminal of the inverter circuit 96 is connected to the terminal OUTLW. The terminal OUTLU is connected to the gate of the switching element 44, the terminal OUTLV is connected to the gate of the switching element 45, and the terminal OUTLW is connected to the gate of the switching element 46.

The reference potential terminals (the first reference potential terminals) of the inverter circuits 91, 92, and 93 are connected to the terminal COM, and connected to GND. The reference potential terminal (a second reference potential terminal) of the inverter circuit 94 is connected to the terminal VSLU. The terminal VSLU is connected to the emitter of the switching element 44, the anode of the FWD 54, and the terminal NU, which are illustrated in FIG. 4.

The reference potential terminal (the second reference potential terminal) of the inverter circuit 95 is connected to the terminal VSLV. The terminal VSLV is connected to the emitter of the switching element 45, the anode of the FWD 55, and the terminal NV, which are illustrated in FIG. 4. The reference potential terminal (the second reference potential terminal) of the inverter circuit 96 is connected to the terminal VSLW. The terminal VSLW is connected to the emitter of the switching element 46, the anode of the FWD 56, and the terminal NW, which are illustrated in FIG. 4.

### Switching Elements 41, 42, 43, 44, 45, and 46

The switching elements 41, 42, 43, 44, 45, and 46 switch the voltage applied from the power supply 14 to the motor 13. The switching elements 41, 42, 43, 44, 45, and 46 are, for example, high-voltage switching elements. 118 Each of the switching elements 41, 42, 43, 44, 45, and 46 according to the present embodiment is, for example, a vertical N-type insulated gate bipolar transistor (IGBT) in which an emitter electrode is formed on the front surface of a substrate and a collector electrode is formed on the back surface of the substrate. The switching elements 41, 42, 43, 44, 45, and 46 are switching elements having, for example, an on-resistance of 10 mΩ and a withstand voltage of several hundred volts.

The switching elements 41, 42, 43, 44, 45, and 46 are not limited to IGBTs, and may be MOS transistors or bipolar transistors.

### Configuration Example of Inverter Circuits 71, 91, 92, and 93

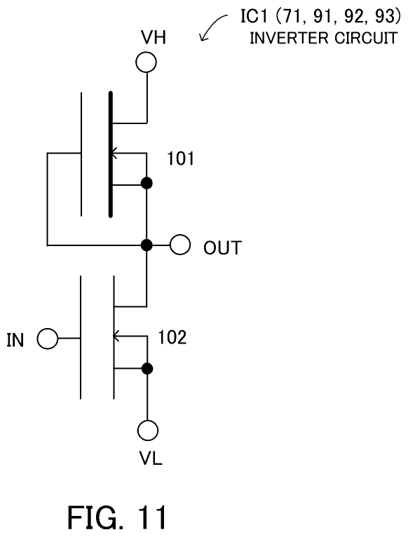

FIG. 11 is a diagram illustrating a configuration example of an inverter circuit. This inverter circuit IC1 corresponds to the inverter circuits 71, 91, 92, and 93 described above. The inverter circuit IC1 includes a terminal IN, a terminal OUT, a terminal VH (a high-potential-side terminal), a terminal VL (a low-potential-side terminal), and MOS transistors 101 and 102.

The MOS transistors 101 and 102 are NMOS transistors. As the MOS transistor 101, a depletion-type NMOS transistor in which the gate-source voltage is 0 V and a current flows between the drain and the source is used. The inverter circuit IC1 inverts the voltage level of the terminal IN and outputs the inverted voltage level to the terminal OUT.

The terminal VH is connected to the drain of the MOS transistor 101. The gate of the MOS transistor 101 is connected to the source of the MOS transistor 101, the terminal OUT, and the drain of the MOS transistor 102. The terminal IN is connected to the gate of the MOS transistor 102. The terminal VL is connected to the source of the MOS transistor 102.

### Configuration Example of Inverter Circuits 72, 75, 78, 94, 95, and 96

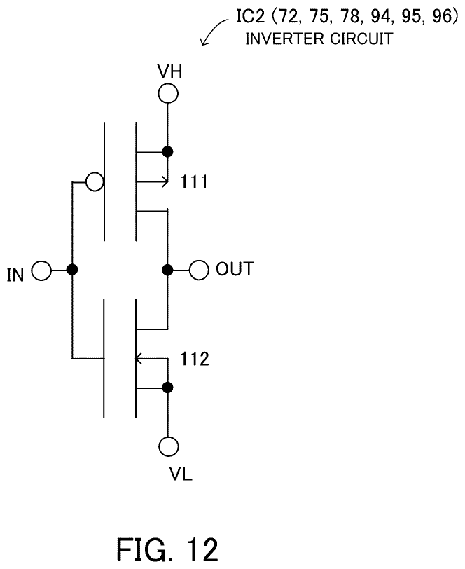

FIG. 12 is a diagram illustrating a configuration example of an inverter circuit. This inverter circuit IC2 corresponds to the inverter circuits 72, 75, 78, 94, 95, and 96 described above. The inverter circuit IC2 includes a terminal IN, a terminal OUT, a terminal VH (a high-potential-side terminal), a terminal VL (a low-potential-side terminal), and MOS transistors 111 and 112. The MOS transistor 111 is a PMOS transistor, and the MOS transistor 112 is an NMOS transistor. The inverter circuit IC2 inverts the voltage level of the terminal IN and outputs the inverted voltage level to the terminal OUT.

The terminal IN is connected to the gate of the MOS transistor 111 and the gate of the MOS transistor 112. The terminal VH is connected to the source of the MOS transistor 111. The drain of the MOS transistor 111 is connected to the terminal OUT and the drain of the MOS transistor 112. The terminal VL is connected to the source of the MOS transistor 112.

### Configuration Example of NAND Circuits 81 and 82

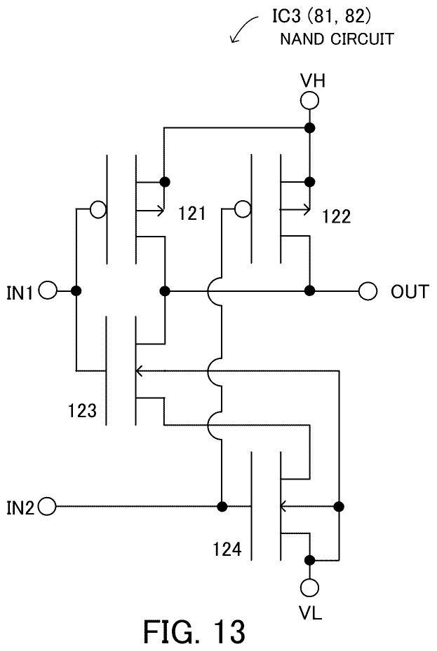

FIG. 13 is a diagram illustrating a configuration example of a NAND circuit. This NAND circuit IC3 corresponds to the NAND circuits 81 and 82. The NAND circuit IC3 includes a terminal IN1, a terminal IN2, a terminal OUT, a terminal VH (a high-potential-side terminal), a terminal VL (a low-potential-side terminal), and MOS transistors 121, 122, 123, and 124. The MOS transistors 121 and 122 are PMOS transistors. The MOS transistors 123 and 124 are NMOS transistors.

The terminal IN1 is connected to the gate of the MOS transistor 121 and the gate of the MOS transistor 123. The terminal IN2 is connected to the gate of the MOS transistor 122 and the gate of the MOS transistor 124.

The terminal VH is connected to the source of the MOS transistor 121 and the source of the MOS transistor 122. The terminal OUT is connected to the drain of the MOS transistor 121, the drain of the MOS transistor 122, and the drain of the MOS transistor 123.

The terminal VL is connected to the back gate of the MOS transistor 123, the back gate of the MOS transistor 124, and the source of the MOS transistor 124. The source of the MOS transistor 123 is connected to the drain of the MOS transistor 124.

Here, when both the voltage levels of the terminal IN1 and the terminal IN2 are the Hi level, the voltage level of the terminal OUT represents the Lo level. In the other cases, the voltage level of the terminal OUT represents the Hi level.

### Relationship Between Drive Signals of Switching Elements and Currents Flowing Through Coils

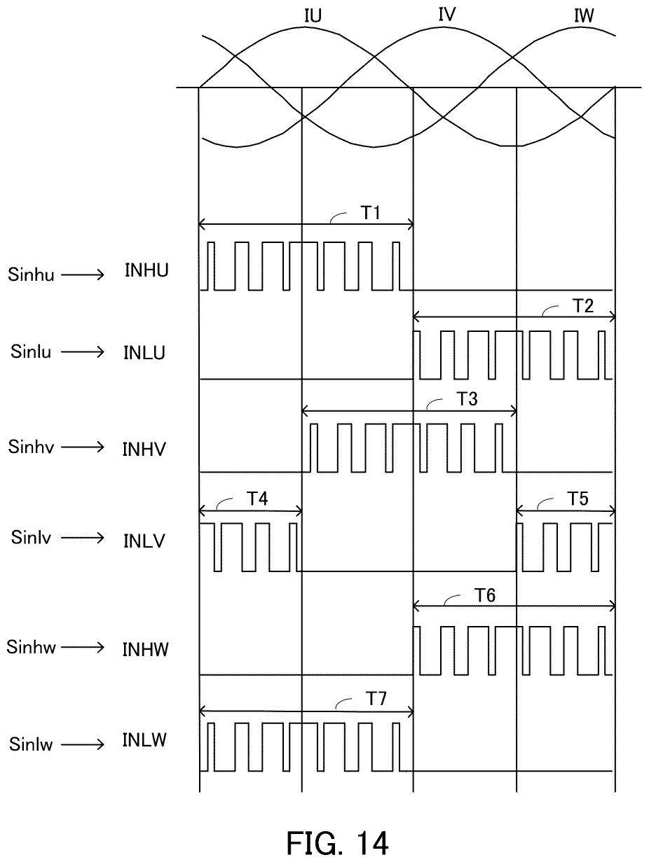

FIG. 14 is a diagram illustrating an example of the relationship between the drive signals of switching elements and the currents flowing through the coils. Three-phase alternating currents whose phases are shifted from each other by 120° flow through the U-phase coil 301, the V-phase coil 302, and the W-phase coil 303 of the motor 13, and rotate the motor 13.

In this case, in a section T1, the upper arm drive signal Sinhu is input to the terminal INHU, and switching drive of the switching element 41 is executed. In a section T2, the lower arm drive signal Sinlu is input to the terminal INLU, and switching drive of the switching element 44 is executed.

In a period T3, the upper arm drive signal Sinhv is input to the terminal INHV, and switching drive of the switching element 42 is executed. In periods T4 and T5, the lower arm drive signal Sinlv is input to the terminal INLV, and switching drive of the switching element 45 is executed.

Further, in a period T6, the upper arm drive signal Sinhw is input to the terminal INHW, and switching drive of the switching element 43 is executed. In a period T7, the lower arm drive signal Sinlw is input to the terminal INLW, and switching drive of the switching element 46 is executed.

### Current Monitoring Function Using Shunt Resistors in Lower Arm Control Circuit 34

In the semiconductor control device 21, when the upper arm switching elements are turned off and the lower arm switching elements are turned on, a current (emitter current) flows to the emitters of the lower arm switching elements. Next, when the lower arm switching elements are turned off, the emitter current decreases and is interrupted.

The lower arm control circuit 34 has a function of monitoring a current flowing by this switching drive. Specifically, the lower arm control circuit 34 monitors the emitter current of the lower arm switching element 44 based on a voltage generated in the external resistor Rs1 connected between the terminal NU and the terminal COM, and detects the current IU of the U-phase coil 301 based on the monitoring result.

The lower arm control circuit 34 monitors the emitter current of the lower arm switching element 45 based on a voltage generated in the external resistor Rs2 connected between the terminal NV and the terminal COM, and detects the current IV of the V-phase coil 302 based on the monitoring result.

Further, the lower arm control circuit 34 monitors the emitter current of the lower arm switching element 46 based on a voltage generated in the external resistor Rs3 connected between the terminal NW and the terminal COM, and monitors the current IW of the W-phase coil 303 based on the monitoring result.

In this way, in the lower arm control circuit 34, the emitter currents of the individual layers of the lower arm switching elements are monitored using their respective shunt resistors (Rs1, Rs2, and Rs3). As a result, because the amounts of currents flowing through the coils of the motor 13 are adjusted from their respective monitoring results, the amounts of the currents IU, IV, and IW flowing through the motor 13 are optimized. In addition, when an overcurrent occurs, it is possible to execute protection control. For example, when the lower-arm control circuit 34 recognizes that a current value being monitored represents a threshold value or greater, the lower-arm control circuit 34 stops the driving of the corresponding lower arm switching element to interrupt the current.

### Configuration Example of Switching Drive Unit of Lower Arm Control Circuit According to Reference Example

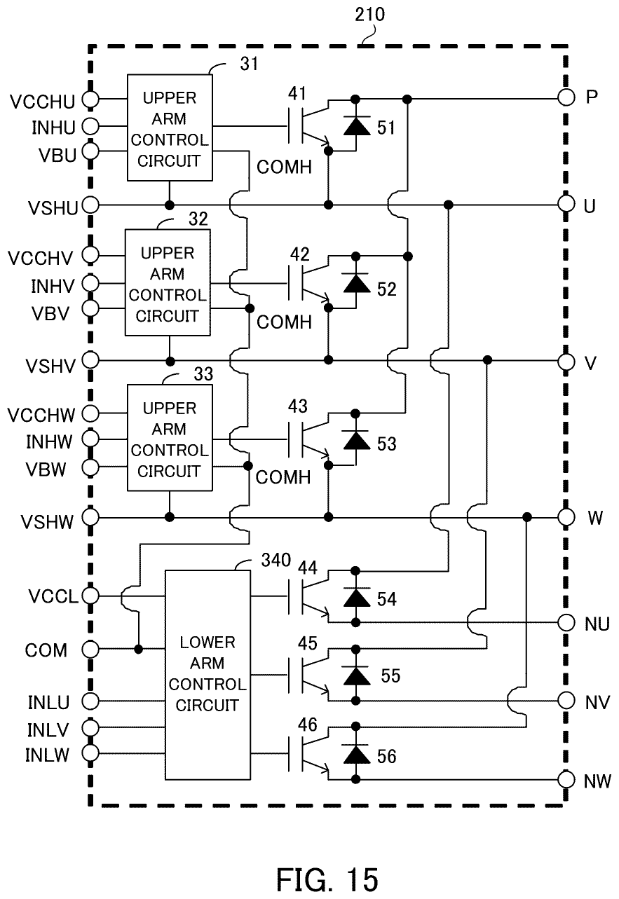

FIG. 15 is a diagram illustrating an internal configuration example of a semiconductor control device according to a reference example. This semiconductor control device 210 according to the reference example includes upper arm control circuits 31, 32, and 33, a lower arm control circuit 340, switching elements 41, 42, 43, 44, 45, and 46, and FWDs 51, 52, 53, 54, 55, and 56. 146 The semiconductor control device 210 includes the lower arm control circuit 340 instead of the lower arm control circuit 34 illustrated in FIG. 4. The connection configuration of the emitters of the switching elements 44, 45, and 46 is different from the connection configuration illustrated in FIG. 4.

That is, the emitter of the switching element 44 is connected to the anode of the FWD 54 and a terminal NU. The emitter of the switching element 45 is connected to the anode of the FWD 55 and a terminal NV. The emitter of the switching element 46 is connected to the anode of the FWD 56 and a terminal NW. Other configurations are the same as those in FIG. 4.

### Configuration Example of Switching Drive Unit of Lower Arm Control Circuit 340 According to Reference Example

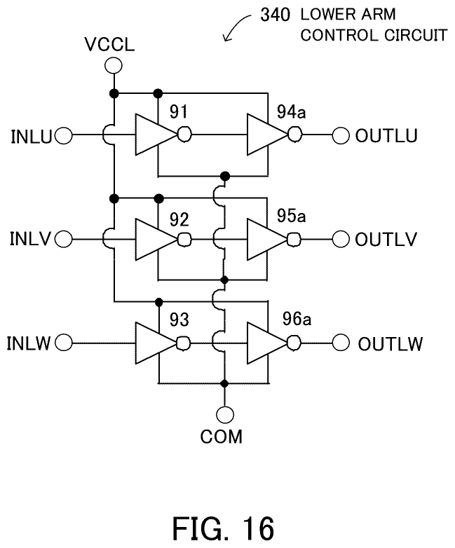

FIG. 16 is a diagram illustrating a configuration example of a switching drive unit of the lower arm control circuit according to the reference example. The lower arm control circuit 340 includes a terminal VCCL, a terminal COM, a terminal INLU, a terminal INLV, a terminal INLW, a terminal OUTLU, a terminal OUTLV, a terminal OUTLW, inverter circuits 91, 92, and 93, and inverter circuits 94a, 95a, and 96a.

The connection configuration of the reference potential terminals of the inverter circuits of the output part of the lower arm control circuit 340 is different from the connection configuration illustrated in FIG. 10. That is, the reference potential terminals of the inverter circuits 94a, 95a, and 96a are connected to the terminal COM and connected to GND, as with the reference potential terminals of the inverter circuits 91, 92, and 93. Other configurations are the same as those in FIG. 10.

### Switching Loss and Current Change Rate

In the inverter apparatus for driving the motor, since the potential of the emitter of each upper arm switching element fluctuates between the low potential side and the high potential side of the power supply Vdd, the upper arm control circuits (HVICs) drive their respective upper arm switching elements by using the emitters of these upper arm switching elements as a reference potential.

Therefore, there is no parasitic inductance between each upper arm switching element and the reference potential of its corresponding HVIC, and an increase in dI/dt, which is a current change rate when the current of a switching element changes, is not hindered with respect to the upper arm switching element.

Further, since the reference potential of the HVIC changes with respect to the reference potential of the power supply Vcc, the reference potentials of the U phase, the V phase, and the W phase need to be separated from each other. In general, the HVIC chip is separated for each phase, and the power supply VCC is also separated for each phase. For example, in the case of the configuration illustrated in FIG. 4, the power supplies of the upper arm control circuits 31, 32, and 33 are separated by the terminal VccHU, the terminal VccHV, and the terminal VccHW, and the reference potentials of the upper arm control circuits 31, 32, and 33 are separated by the terminal VSHU, the terminal VSHV, and the terminal VSHW.

On the other hand, since the potentials of the emitters of the lower arm switching elements are substantially equal to the GND potential in a steady state, it is possible to drive the lower arm switching elements by setting the reference potential of the lower arm control circuit (LVIC) to the same potential as the GND potential. However, when the potential of an individual gate is set to the Lo level (for example, 0 V) to turn off its corresponding lower arm switching element and the current consequently decreases, the potential of the emitter of the lower arm switching element decreases due to the parasitic inductance. Therefore, the potential difference between the gate and the emitter of the lower arm switching element becomes smaller than 0 V, and an increase in dI/dt is prevented. In addition, a decrease in dI/dt results in an increase in switching loss.

In order to reduce the switching loss, the reference potential and the power supply of the LVIC may be separated for each phase, as with the HVIC. In this way, it is possible to prevent a decrease in dl/dt. However, such a configuration involves an increase in chip size, an increase in the number of terminals, an increase in the number of power supplies, and the like, thereby increasing the device size and cost. The present embodiment has been made in view of these points, and reduces the switching loss without increasing the device size and cost.

### Timing at Switching Drive According to Present Embodiment

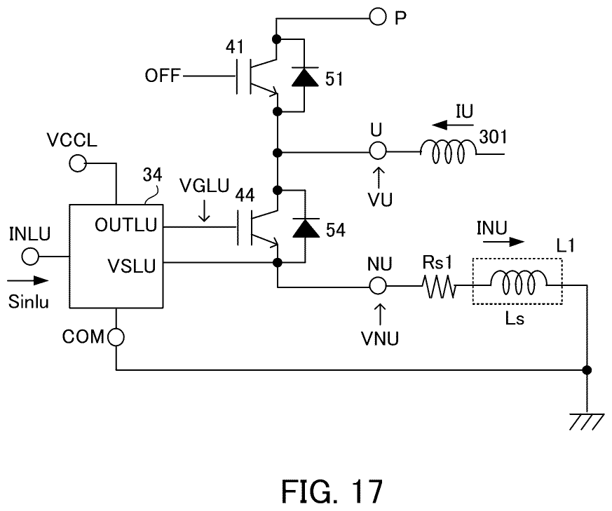

Next, the timing at the time of switching drive according to the present embodiment will be described with reference to FIGS. 17 to 19. Since the inverted U phase, the inverted V phase, and the inverted W phase have the same configuration and control, the inverted U phase will be described below.

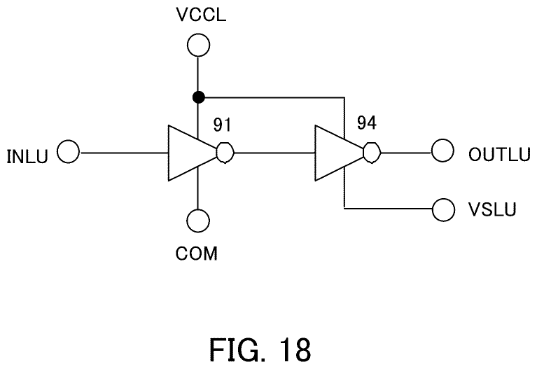

FIG. 17 is a diagram illustrating an example of a peripheral circuit configuration of a switching element according to the present embodiment. FIG. 17 illustrates a peripheral circuit configuration of the inverted U-phase switching element 44. FIG. 18 is a diagram illustrating a configuration example of the switching drive unit of the lower arm control circuit according to the present embodiment. FIG. 17 illustrates a circuit around the inverted U-phase switching element in FIG. 4, and FIG. 18 illustrates the inverted U-phase circuit of the switching drive unit in the lower arm control circuit 34 in FIG. 10. Therefore, the description of the connection relationship is omitted.

In the semiconductor control device 21, as described above, one end of a current-detection resistor is connected between the electrode of the emitter (the low potential side) of its corresponding lower arm switching element and the GND, and the terminal COM and the other end of the resistor are connected to the GND. In this connection configuration, there is a parasitic inductance in the substrate wiring.

In the case of FIG. 17, one end of the current-detection resistor Rs1 is connected between the emitter of the switching element 44 and the GND via the terminal NU. The parasitic inductance L1 is present between the terminal COM and the other end of the resistor Rs1, and the other end of the resistor Rs1 is connected to the terminal COM and the GND via the parasitic inductance L1. The voltage of the gate of the switching element 44 is VGLU, the voltage of the terminal U is VU, and the voltage of the terminal NU is VNU.

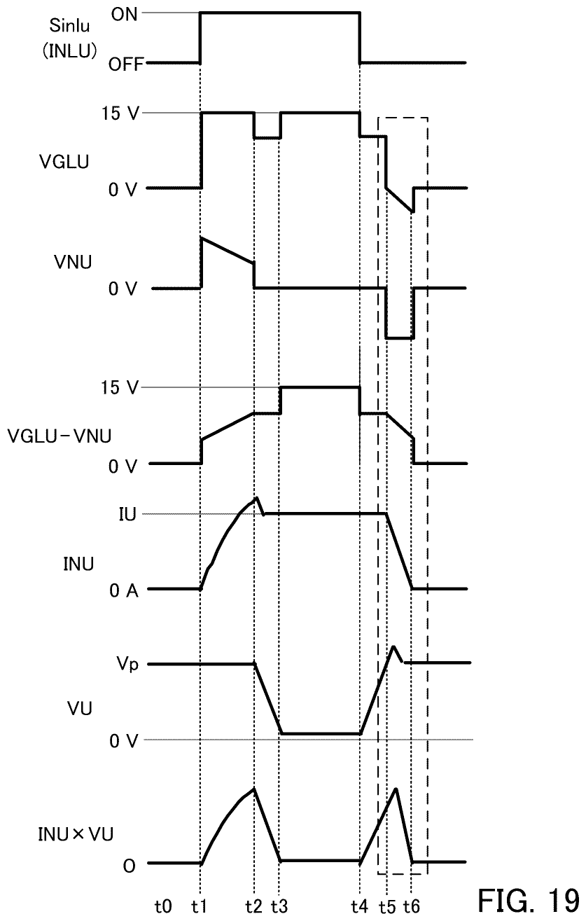

FIG. 19 is a diagram illustrating an example of timing at the time of a switching operation according to the present embodiment. FIG. 19 schematically illustrates an example of temporal change of voltages and signals in the semiconductor control device 21 in a case where switching drive of the inverted U-phase is executed when the current IU flows through the U-phase coil 301 of the motor 13. The “switching drive” of the inverted U phase of the semiconductor control device 21 refers to a case where the switching element 44 is turned on and off. The direction in which the current IU flows from the coil 301 to the terminal U is defined as positive. The current INU flows through the terminal NU, and the direction in which the current INU flows from the terminal NU to GND is positive.

At time t0, the lower arm drive signal Sinlu, which is transmitted from the control unit 12 and input to the terminal INLU, is at the Lo level, and the switching element 44 is in a turn-off state. Although not illustrated, the upper arm drive signal Sinhu, which is input to the terminal INHU, is also at the Lo level, and the switching element 41 is in a turn-off state. At this time, the current IU flowing through the coil 301 flows from the terminal U to the terminal P via the FWD 51 because both the switching elements 41 and 44 are in a turn-off state. Therefore, the potential VU of the terminal U is approximately equal to the potential Vp of the power supply 14.

At time t1, in order to turn on the switching element 44, the control unit 12 increases the lower arm drive signal Sinlu, which is input to the terminal INLU, from the Lo level to the Hi level. When the potential of the terminal INLU rises to the Hi level, the potential VGLU of the gate of the switching element 44 rises to a voltage (for example, 15 V) applied to the terminal VCCL of the inverter circuit 94. 165 Between time t1 and time t2, because electric charge is supplied from the inverter circuit 94 to the gate of the switching element 44, the gate potential rises. At this time, the current INU gradually increases with dI/dt, which is the current change rate, and the potential VNU decreases. 166 The voltage VNU of the terminal NU is expressed by Ls×dI/dt, where Ls is the parasitic inductance value of the parasitic inductance L1 between the terminal NU and GND, and dI/dt is the current change rate at which the current INU increases. Therefore, since the potential of the emitter of the switching element 44 is higher than the GND (0 V) due to the presence of the parasitic inductance L1, the potential difference VGLU−VNU between the gate and the emitter of the switching element 44 is smaller than 15 V.

Therefore, while electric charge is supplied from the inverter circuit 94 to the gate of the switching element 44, the voltage VNU decreases as dI/dt of the current INU gradually increases. As a result, the potential difference VGLU−VNU increases in a range smaller than 15 V.

At time t2, the current INU of the terminal NU has already increased and exceeded the current IU flowing through the coil 301. This is because, when the switching element 44 is turned on, the current flowing through the FWD 51 flows in the direction of the switching element 44. That is, due to the capacitive property of the FWD 51, when the current once flowing stops flowing, the electric charge charged in the FWD 51 flows to the switching element 44. As a result, the current INU temporarily exceeds the current IU. Since the switching element 44 is turned on and the current INU flows, the voltage VU of the terminal U corresponding to the collector-emitter voltage of the switching element 44 starts to decrease.

When dI/dt becomes constant at 0 between time t2 and time t3, the voltage VNU decreases to approximately 0 V. Since there is capacitance between the gate and the emitter of the switching element 44, the voltage VGLU of the gate also decreases as the voltage VNU decreases. Therefore, the increase in the potential difference VGLU−VNU also stops. The voltage VU of the terminal U continues to decrease.

Between time t3 and time t4, since the current change rate dI/dt of the current INU is constant at 0, the voltage VNU of the terminal NU is approximately 0 V. Further, the voltage VU of the terminal U decreases until dV/dt, which is the voltage change rate, becomes 0. When the rate dV/dt at which the voltage VU decreases becomes constant, the voltage VGLU of the gate and the potential difference VGLU−VNU increase.

At time t4, in order to turn off the switching element 44, the control unit 12 lowers the lower arm drive signal Sinlu, which is input to the terminal INLU, from the Hi level to the Lo level. When the lower arm drive signal Sinlu becomes the Lo level, the voltage VGLU of the gate terminal of the switching element 44 decreases from 15 V, and the voltage VU of the terminal U starts to increase (since the gate voltage of the switching element 44 decreases, the collector voltage increases).

Between time t4 and time t5, the voltage VU of the terminal U continues to increase. At time t5, the voltage VU of the terminal U becomes approximately equal to the power supply voltage Vp. In addition, the current INU, which is the emitter current of the switching element 44, starts to decrease.

Between time t5 and time t6, when the voltage VU, which is the collector voltage of the switching element 44, exceeds the power supply voltage Vp, a current starts to flow through the FWD 54, and the current INU flowing between the collector and the emitter of the switching element 44 decreases. The potential of the terminal VNU connected to the emitter of the switching element 44 is expressed by Ls×(−dI/dt), where Ls is the parasitic inductance value between the terminal NU and the GND, and −dI/dt is the current change rate, at which the current INU decreases. The potential of the terminal VNU becomes smaller than 0 V.

On the other hand, the potential of the output terminal OUTLU of the inverter circuit 94 is at the Lo level, and the reference potential of the inverter circuit 94 is the same as the emitter potential of the switching element 44. Therefore, the current INU decreases without depending on the value of the voltage VNU, the switching element 44 is interrupted without depending on the parasitic inductance value Ls and the current change rate dI/dt, and the current INU continues to decrease. Therefore, the switching loss, which is the time integration value of the power, which is the product of the current INU and the voltage VU (the time integration value of INU×VU), does not increase. At time t6, the current INU, dI/dt, and the voltage VNU of the terminal NU become 0, and the same state as that at time t0 is restored.

### Timing at Switching Drive According to Reference Example

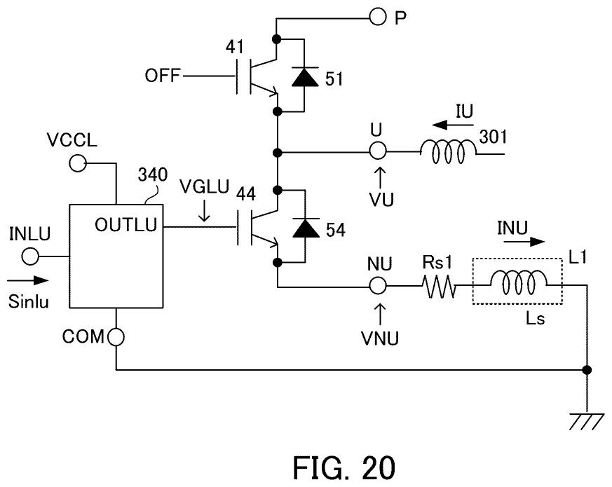

Next, timing at the time of switching drive according to the reference example will be described with reference to FIGS. 20 to 22. FIG. 20 is a diagram illustrating an example of a peripheral circuit configuration of a switching element according to the reference example. FIG. 20 illustrates a peripheral circuit configuration of the inverted U-phase switching element 44. In the configuration according to the reference example, the lower arm control circuit 340 is provided instead of the lower arm control circuit 34 illustrated in FIG. 17, and the connection configuration of the emitter of the switching element 44 is different from the connection configuration illustrated in FIG. 17. That is, the emitter of the switching element 44 is connected to the anode of the FWD 54 and the terminal NU. Other configurations are the same as those in FIG. 17.

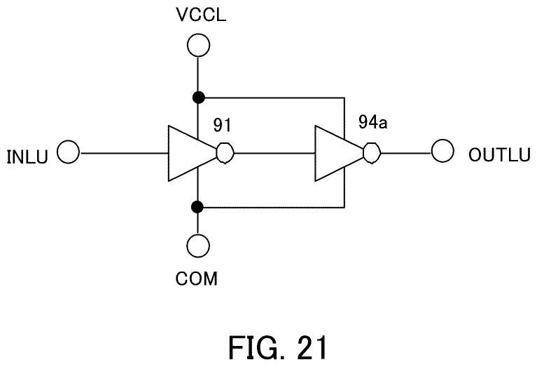

FIG. 21 is a diagram illustrating a configuration example of the switching drive unit of the lower arm control circuit according to the reference example. The connection configuration of the ground terminal of the inverter circuit of the output part of the lower arm control circuit 340 is different from the connection configuration illustrated in FIG. 18. That is, the reference potential terminal of the inverter circuit 94a is connected to the terminal COM and is connected to the GND, as with the reference potential terminal of the inverter circuit 91. Other configurations are the same as those in FIG. 18.

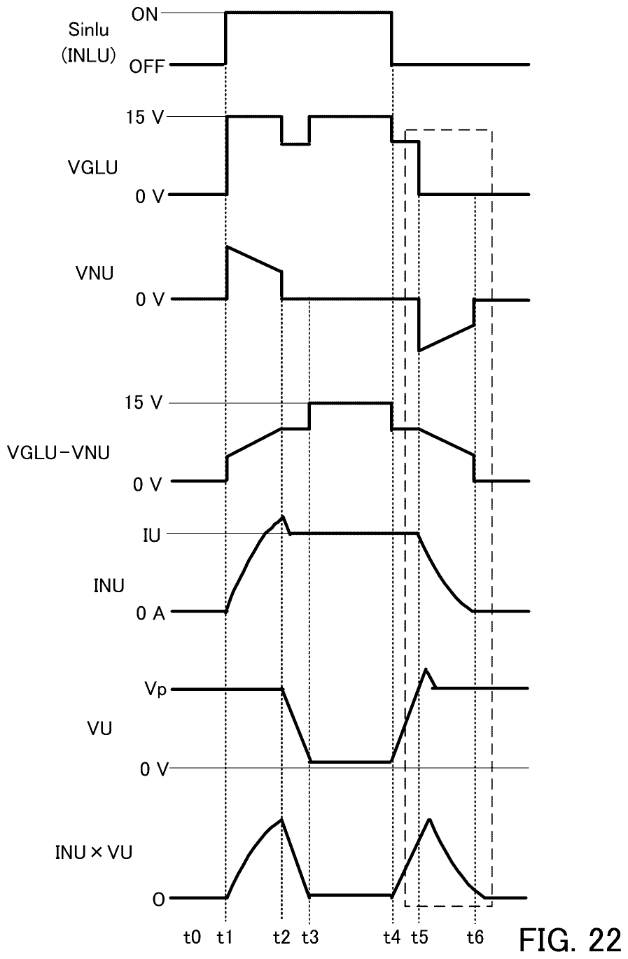

FIG. 22 is a diagram illustrating an example of timing at the time of a switching operation according to the reference example. FIG. 22 schematically illustrates an example of temporal change in voltages and signals in the semiconductor control device 210 in a case where switching drive of the inverted U phase is executed when the current IU flows through the coil 301 of the motor 13. From time t0 to time t5, the switching operation is the same as that in FIG. 19.

From time t5 to time t6, when the current INU decreases and becomes equal to the current that the switching element 44 is able to output with the gate voltage of the potential difference VGLU−VNU, because VNU needs to increase in order to further decrease the current INU, dI/dt of the current INU decreases. Therefore, the switching loss, which is the time integration value of the power (the time integration value of INU×VU), which is the product of the current INU and the voltage VU, increases between time t5 and time t6.

As described above, in the configuration according to the reference example, the emitter potential of the switching element 44 is expressed by Ls×(−dI/dt) due to the current decrease (the current change rate is −dI/dt) that occurs during the current interruption when the switching element 44 is in the turn-off state. Therefore, the emitter potential becomes a negative voltage, and the current decrease of the switching element 44 is prevented. Therefore, it is difficult to shorten the current interruption time, and the reduction of the switching loss is limited.

### Comparison Between Present Embodiment and Reference Example in Switching Drive Timing

When the switching element 44 is switched from the turn-on state to the turn-off state, the gate-emitter voltage of the switching element 44 is reduced. On the other hand, in the reference example, the gate potential is at a fixed 0 level, and the emitter potential is at a negative level due to the presence of the parasitic inductance L1. Therefore, the potential difference between the gate and the emitter is large.

Therefore, in order to reduce the gate-emitter voltage (in order to reduce the gate-emitter potential difference), the emitter potential needs to be increased from the negative voltage level. In FIG. 22, VGLU is at the 0 level, and VNU corresponding to the emitter potential gradually increases from the negative level in the positive level direction.

The emitter potential is determined by the product (Ls×dI/dt) of the parasitic inductance value Ls and dI/dt of the current flowing between the collector and the emitter of the switching element 44. Therefore, dI/dt needs to be reduced in order to increase the emitter potential. However, when dI/dt is reduced, the turn-off speed of the switching element 44 is reduced, and the turn-off time is consequently extended (FIG. 22 illustrates that the time period from time t5 to time t6 is longer than the same time period in FIG. 19). Therefore, in the configuration of the semiconductor control device 210 according to the reference example, the switching loss increases when the switching element 44 is turned off.

In contrast, in the present embodiment, the reference potential terminal of the inverter circuit 94 is connected to the emitter of the switching element 44 and is common to the emitter potential. Therefore, in the case where the gate-emitter voltage of the switching element 44 is reduced when the switching element 44 is turned off, since the gate potential and the emitter potential are linked to each other, when the emitter potential becomes a negative voltage level, the gate potential also becomes a negative voltage level.

Therefore, even if the emitter potential becomes a negative voltage level due to the presence of the parasitic inductance L1, in the configuration according to the present embodiment, the gate potential also becomes a negative voltage level in conjunction with the emitter potential. That is, since the gate potential and the emitter potential are subjected to the same potential fluctuation, the potential difference between the gate and the emitter does not increase.

Therefore, dI/dt of the current INU is determined by dV/dt of the voltage change rate of the gate-emitter voltage without depending on the parasitic inductance value Ls. Therefore, the turn-off speed of the switching element 44 does not decrease, and the turn-off time does not extend (FIG. 19 illustrates that the time period from time t5 to time t6 is shorter than the same time period in FIG. 22). Therefore, in the configuration of the semiconductor control device 21 according to the present embodiment, reduction in switching loss is achieved when the switching element 44 is turned off.

### Simulation Waveforms

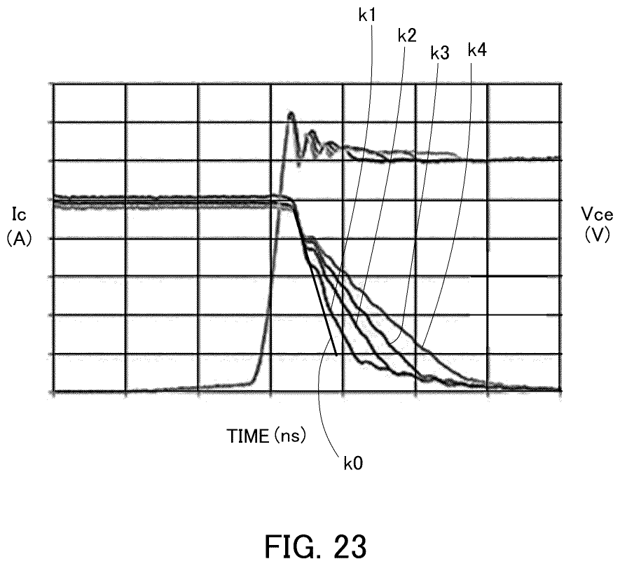

Next, simulation waveforms illustrating characteristics when a lower arm switching element is turned off will be described with reference to FIGS. 23 to 26. FIG. 23 is a diagram illustrating an example of the dependence of a collector current on a parasitic inductance. The horizontal axis represents time (ns), and the left vertical axis represents a collector current Ic (A) of a lower arm switching element. The right vertical axis represents a collector-emitter voltage Vce (V) of the lower arm switching element.

FIG. 23 illustrates the waveforms of the collector current Ic when the parasitic inductance value Ls is increased in the order of waveforms k1, k2, k3, and k4. The waveforms k1, k2, k3, and k4 represent the collector current Ic when the parasitic inductance value Ls is 10 nH, 20 nH, 30 nH, and 40 nH, respectively. A waveform k0 represents the collector current Ic when the influence of the parasitic inductance value Ls is excluded according to the present embodiment.

When the lower arm switching element is turned off and the collector current Ic decreases, dI/dt of the collector current Ic changes due to the parasitic inductance. In this case, as the parasitic inductance value Ls increases, dI/dt is prevented from increasing (dI/dt becomes gradual), and the current interruption time becomes longer. On the other hand, in the configuration according to the present embodiment having the characteristics of the waveform k0 not affected by the parasitic inductance value Ls, the increase in dI/dt is not prevented, and thus the current interruption time is shortened.

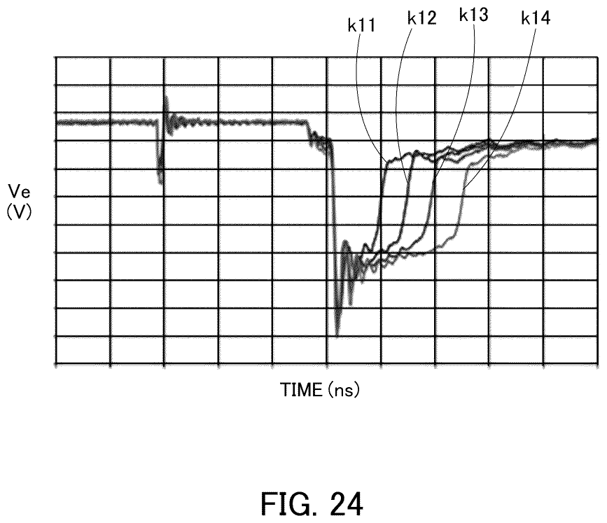

FIG. 24 is a diagram illustrating an example of the dependence of the emitter voltage on the parasitic inductance. The horizontal axis represents time (ns), and the vertical axis represents an emitter voltage Ve (V) (the voltage between the emitter and GND) of the lower arm switching element. FIG. 24 illustrates the emitter voltage Ve when the parasitic inductance value Ls is increased in the order of waveforms k11, k12, k13, and k14. The waveforms k11, k12, k13, and k14 represent the emitter voltage Ve when the parasitic inductance value Ls is 10 nH, 20 nH, 30 nH, and 40 nH, respectively.

When the lower arm switching element is turned off and the collector current Ic decreases, the emitter voltage Ve of the lower arm switching element becomes a negative voltage smaller than 0 V due to the parasitic inductance. At this time, as the parasitic inductance value Ls increases, the time period in which the voltage is negative is extended, and as the time period is extended, dI/dt further decreases and an increase in dI/dt is prevented.

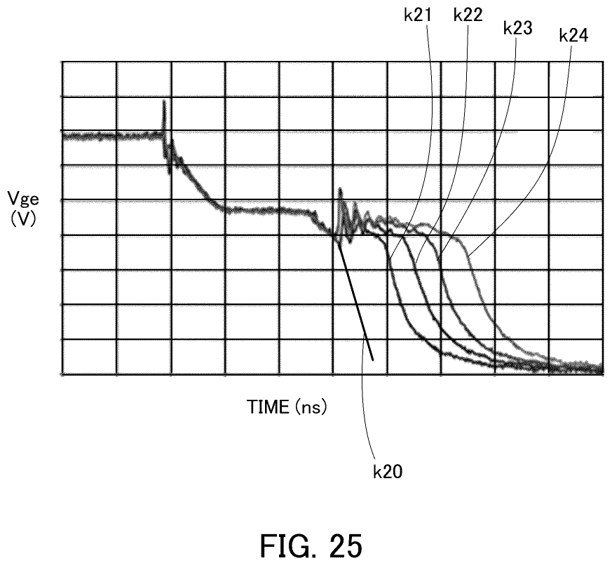

FIG. 25 is a diagram illustrating an example of the dependence of the gate-emitter voltage on the parasitic inductance. The horizontal axis represents time (ns), and the vertical axis represents a gate-emitter voltage Vge (V) of the lower arm switching element. FIG. 25 illustrates the gate-emitter voltage Vge when the parasitic inductance value Ls is increased in the order of waveforms k21, k22, k23, and k24. The waveforms k21, k22, k23, and k24 are the gate-emitter voltage Vge when the parasitic inductance value Ls is 10 nH, 20 nH, 30 nH, and 40 nH, respectively. A waveform k20 represents the gate-emitter voltage Vge when the influence of the parasitic inductance value Ls is excluded according to the present embodiment.

In the configuration having the characteristics of the waveforms k21, k22, k23, and k24 affected by the parasitic inductance value Ls, since the emitter potential becomes a negative voltage, the voltage of the gate-emitter voltage Vge gradually changes, and the interruption time of the collector current Ic is extended. On the other hand, in the configuration according to the present embodiment having the characteristics of the waveform k20 not affected by the parasitic inductance value Ls, the increase in dI/dt is not prevented, the voltage change is accelerated, and the interruption time of the collector current Ic is consequently shortened.

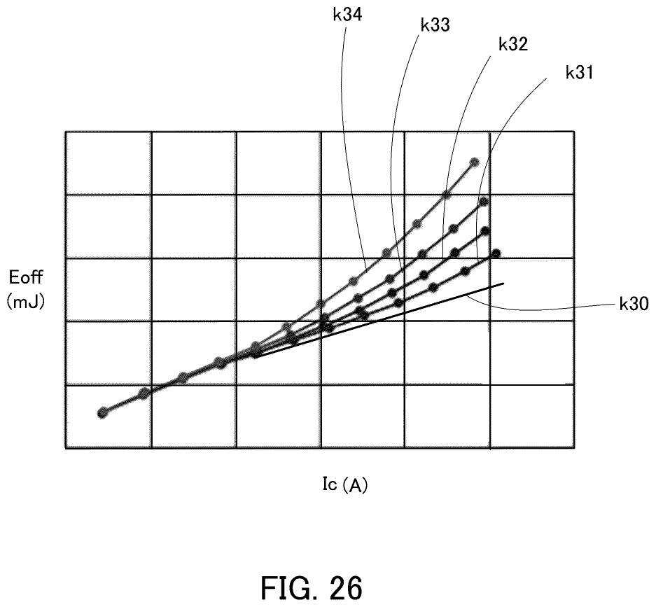

FIG. 26 is a diagram illustrating an example of the dependence of switching loss on the parasitic inductance. The horizontal axis represents the collector current Ic (A) of the lower arm switching element, and the vertical axis represents switching loss Eoff (mJ). FIG. 26 illustrates the switching loss Eoff when the parasitic inductance value Ls is increased in the order of waveforms k31, k32, k33, and k34.

The waveforms k31, k32, k33, and k34 represent the switching loss Eoff when the parasitic inductance value Ls is 10 nH, 20 nH, 30 nH, and 40 nH, respectively. A waveform k30 represents the switching loss Eoff when the influence of the parasitic inductance value Ls is excluded according to the present embodiment.

In the configuration having the characteristics of the waveforms k31, k32, k33, and k34 affected by the parasitic inductance value Ls when the lower arm switching element is off, as the parasitic inductance value Ls increases, the current interruption time increases with an increase in the collector current Ic, and the switching loss Eoff increases. On the other hand, in the configuration according to the present embodiment having the characteristics of the waveform k30 not affected by the parasitic inductance value Ls, the switching loss Eoff is reduced because the current interruption time is shortened.

### Structure of Lower Arm Control Circuit 34

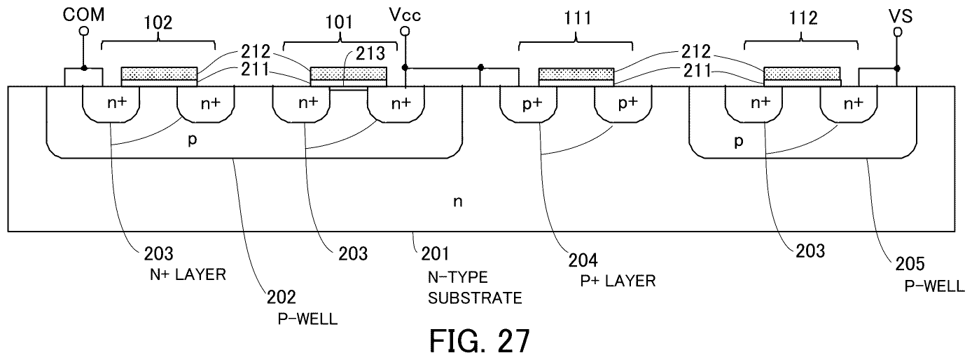

FIG. 27 is a diagram illustrating an example of a cross-sectional structure of a main part of the lower arm control circuit according to the present embodiment.

### (Structure of Depression-Type MOS Transistor 101)

A P-well 202 is formed on the surface of an N-type substrate 201, and an N−layer 213, a gate oxide film 211, and a gate electrode 212 are stacked on the P-well 202. N+ layers 203 are formed by ion implantation using the gate oxide film 211 and the gate electrode 212 as a mask. The N+ layers 203 are used as a drain electrode and a source electrode. A terminal COM is formed on the P-well 202.

### (Structure of MOS Transistors 102 and 112)

P-wells 202 and 205 are formed on the surface of the N-type substrate 201, and a gate oxide film 211 and a gate electrode 212 are stacked on each of the P-wells 202 and 205. A pair of N+ layers 203 is formed by ion implantation using its corresponding gate oxide film 211 and gate electrode 212 as a mask. Each pair of N+ layers 203 are used as a drain electrode and a source electrode. A terminal VS is formed on the P-well 205. The terminal VS corresponds to a terminal VCLU, a terminal VSLV, and a terminal VSLW.

### (Structure of MOS Transistor 111)

A gate oxide film 211 and a gate electrode 212 are stacked on the N-type substrate 201. P+ layers 204 are formed by ion implantation using the gate oxide film 211 and the gate electrode 212 as a mask. The P+ layers 204 are used as a drain electrode and a source electrode.

As described above, the lower arm control circuit 34 is formed on the N-type substrate 201, the first reference potential terminal (the terminal COM) of the first circuit 1b1 is formed on the P-well 202 (a first P-well), the second reference potential terminal (the terminal VS) of the second circuit 1b2 is formed on the P-well 205 (a second P-well) separated from the P-well 202, and the reference potential of the second circuit 1b2 of the output part of the lower arm control circuit 34 is common to the emitter potential of the lower arm switching element.

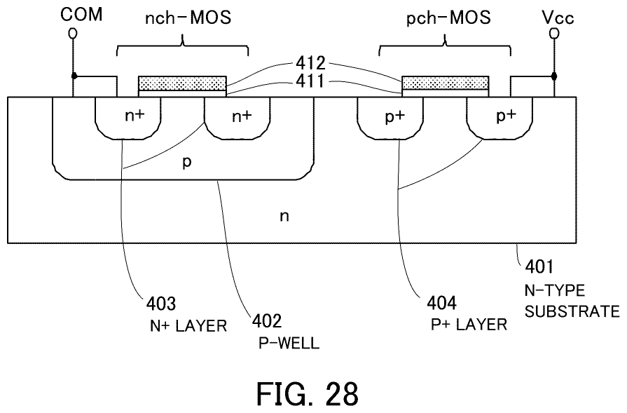

FIG. 28 is a diagram illustrating an example of a cross-sectional structure of a main part of the lower arm control circuit according to the reference example. FIG. 28 illustrates a cross-sectional structure of the output part of the lower arm control circuit 340. Regarding an nch-MOS transistor, a P-well 402 is formed on the surface of an N-type substrate 401, and a gate oxide film 411 and a gate electrode 412 are stacked on the P-well 402. N+ layers 403 are formed by ion implantation using the gate oxide film 411 and the gate electrode 412 as a mask. The N+ layers 403 are used as a drain electrode and a source electrode. A terminal COM is formed on the P-well 402.

Regarding a pch-MOS transistor, a gate oxide film 411 and a gate electrode 412 are stacked on the N-type substrate 401. P+ layers 404 are formed by ion implantation using the gate oxide film 411 and the gate electrode 412 as a mask. The P+ layers 404 are used as a drain electrode and a source electrode.

As described above, according to the present embodiment, the reference potential terminals (the terminal VSLU, the terminal VSLV, and the terminal VSLW) of the output part of the lower arm control circuit are connected to the emitters of their respective lower arm switching elements. In this way, when a lower arm switching element is turned off, it is possible to suppress an increase in switching loss due to the parasitic inductance value between the emitter of the lower arm switching element and the GND and due to the current change rate dI/dt of the current flowing through the parasitic inductance. In addition, it is possible to increase dI/dt of the current change rate by suppressing the limitation of the parasitic inductance without increasing the device size and the cost. Thus, the degree of freedom in mounting the semiconductor device is improved.

According to one aspect, the switching loss is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A semiconductor device for operating a load, comprising:
a switching circuit which includes a lower arm switching element, the switching circuit being connected to the load, and being configured to operate the load based on switching drive of the lower arm switching element; and
a lower arm control circuit, which includes:
a first circuit that uses a ground potential as a reference potential thereof, receives a lower arm drive signal, generates a first drive signal from the received lower arm drive signal, and outputs the first drive signal, and
a second circuit that uses a floating potential, different from the ground potential, as a reference potential thereof, executes level inversion of the first drive signal to generate a second drive signal, and executes the switching drive of the lower arm switching element based on the second drive signal.

2. The semiconductor device according to claim 1, wherein
the semiconductor device further includes a resistive element having a first end and a second end, and
the lower arm switching element has a low-potential-side electrode, which is configured to have the first end of the resistive element connected thereto of, while the second end of the resistive element is grounded.

3. The semiconductor device according to claim 2, wherein the floating potential is a potential generated at the low-potential-side electrode of the lower arm switching element.

4. The semiconductor device according to claim 3, wherein:
the switching circuit further includes an upper arm switching element,
the lower arm switching element further has a control electrode, and
the switching circuit and the lower arm control circuit are so configured that, in a case where the upper arm switching element is turned off, the lower arm control circuit turns off the lower arm switching element by decreasing a voltage between the control electrode and the low-potential-side electrode of the lower arm switching element, a potential of the control electrode and a potential of the low-potential-side electrode of the lower arm switching element being linked to each other, and a potential difference therebetween being set within a predetermined range.

5. The semiconductor device according to claim 1, wherein the first circuit generates the first drive signal by level-shifting a first voltage level of the received lower arm drive signal to a second voltage level higher than the first voltage level.

6. The semiconductor device according to claim 5, wherein
the first circuit includes a first inverter circuit using the ground potential as a reference potential of the first inverter circuit, and
the second circuit includes a second inverter circuit using the floating potential as a reference potential of the second inverter circuit.

7. The semiconductor device according to claim 5, wherein
the first circuit includes an odd number of first inverter circuits connected in series, each of the first inverter circuits using the ground potential as a reference potential thereof; and
the second circuit includes the odd number of second inverter circuits connected in series, each of the second inverter circuits using the floating potential as a reference potential thereof.

8. The semiconductor device according to claim 1,
wherein the switching circuit further includes:
an upper arm switching element having an upper arm high-potential-side electrode and an upper arm low-potential-side electrode,
an upper arm freewheeling diode having an anode and a cathode thereof, and
a lower arm freewheeling diode having an anode and a cathode thereof,
wherein the lower arm switching element has a lower arm high-potential-side electrode, a lower arm low-potential-side electrode, and a control electrode,
wherein the first circuit includes:
a first reference potential terminal, and
a single first inverter circuit using the ground potential as a reference potential thereof via the first reference potential terminal,
wherein the second circuit includes:
a second reference potential terminal, and
a single second inverter circuit using the floating potential as a reference potential thereof via the second reference potential terminal,
wherein the semiconductor device further includes a resistive element having a first end and a second end,
wherein the floating potential is a potential generated at the lower arm low-potential-side electrode,
wherein the upper arm high-potential-side electrode is connected to the cathode of the upper arm freewheeling diode, and is configured to receive a power supply voltage,
wherein the upper arm low-potential-side electrode is connected to the anode of the upper arm freewheeling diode, the load, the lower arm high-potential-side electrode, and the cathode of the lower arm freewheeling diode,
wherein the first inverter circuit generates the first drive signal from the received lower arm drive signal and outputs the first drive signal,
wherein the second inverter circuit has an output terminal, and is configured to execute the level inversion of the first drive signal to generate the second drive signal, and to output the second drive signal from the output terminal,
wherein the control electrode of the lower arm switching element is connected to the output terminal of the second inverter circuit,
wherein the lower arm low-potential-side electrode is connected to the anode of the lower arm freewheeling diode, the first end of the resistive element, and the second reference potential terminal of the second inverter circuit, and
wherein the second end of the resistive element is connected to the first reference potential terminal of the first inverter circuit.

9. The semiconductor device according to claim 8, wherein
the lower arm control circuit is located on an N-type substrate, the N-type substrate having a first P-well and a second P-well located on a surface thereof and separate from each other,
the first reference potential terminal of the first circuit is located on the first P-well, and
the second reference potential terminal of the second circuit is located on the second P-well.
